(19) United States
(12) Patent Application Publication
(10) Pub. No.: US 2017/0137267 A1
(43) Pub. Date: May 18, 2017

(54) ROTATING CENTRAL COLUMN WITH HYDRAULIC HORIZONTAL MOVEMENT, ARRANGED IN AN ASSEMBLY FOR CHANGING HOPPERS AND TANKS FOR LORRIES

(71) Applicant: Patricio Francisco Gimenez Vergara, Antofagasta II Region (CL)

(72) Inventor: Patricio Francisco GIMENEZ VERGARA, Antofagasta (CL)

(21) Appl. No.: 15/314,855

(22) PCT Filed: May 28, 2015
(86) PCT No.: PCT/CL2015/000035

§ 371 Date: Nov. 29, 2016

(30) Foreign Application Priority Data
May 30, 2014 (CL) 1442-2014

(51) Int. Cl. B66F 3/46; B66F 3/30; B66F 3/24

(52) U.S. Cl. CPC B66F 3/46; B66F 3/24; B66F 3/30

(57) ABSTRACT

A central column allowing a 360° rotation on its central axis comprises mechanical safety locks and load sensors for safe operation in vertical and horizontal movements. The central rotating column may be part of a mounting and dismounting system for mining truck dump bodies and water truck bodies, providing two adjacent working areas. The lifting system for dump bodies of mining trucks and bodies of water trucks comprises a vertically adjustable mechanical lock; a spring-actuated automatic lock horizontally holding the column in position; an automatic rotation lock preventing the column from rotating while in operation; a toothed crown and pinion assembly integrated to the rotating base and allowing a 360° movement, and a load sensor preventing the horizontal movement of the column under load.

### BACKGROUNDS

At present, in mining operations in Chile and around the world, the exchange of dump bodies of mining trucks and bodies of water trucks is performed with the suspended load working method, using one or two high tonnage loading cranes, equipped with heavy lifting devices.

The state of the art shows two patent applications submitted in Chile, numbered 200302430 and 200701876, which publish a mining truck dump body lifting system comprising four adjustable columns, comprising a vertical travelling support arm; main function of the system is the mounting and dismounting of mine truck bodies; replacing the concept of suspended load and introducing the concept of supported load. In the second patent application, number 200701876, the mining truck dump body lifting system published comprises six adjustable columns. In this system, the two central columns rotate 180°, allowing the operation in two adjacent working areas.

In both systems described in these patent applications, operational risks posed by the vertical and horizontal movements of the columns were identified. Should the lifting column hydraulic cylinder fail to operate, the worker would need to access the vertical travelling support arm climbing up in a ladder up to the position of the supporting arm and then triggering a mechanical locking system with the inherent risk of dump body falling on the operator and/or the operator falling down from height; for these reasons this invention now comprises automatic mechanical safety locks in each column with the purpose of preventing the horizontal and vertical movements of the column; triggering of these locks is made from the base of each column.

Another concern on the prior art relates to the positioning and horizontal movement of the column as the systems published in patent applications numbers 200302430 and 200701876 only include hydraulic locking valves, which in case of failure, do not prevent the horizontal movement of the column under load. For this reason, this invention now comprises load sensors in each column, connected to the lifting system, for the purpose of detecting and locking any horizontal movement of columns under load, thus also preventing the operator from activating a horizontal movement with the columns under load. This sensor is located in the hydraulic lifting system and blocks the horizontal movement.

Also, the frequent use of the 180° toothed crown of the turntable in the central rotating column, results in a quick wear of turntable bearing teeth thus requiring shutting down the lifting system for servicing or repairing worn out parts.

With the purpose of providing a solution to the above mentioned concerns, the design includes a central column allowing a 360° rotation on its central axis, also comprising mechanical safety locks and load sensors for a safe operation in vertical and horizontal movements.

### DESCRIPTION OF THE DRAWINGS

FIG. 1 is a perspective view of the central rotating column.

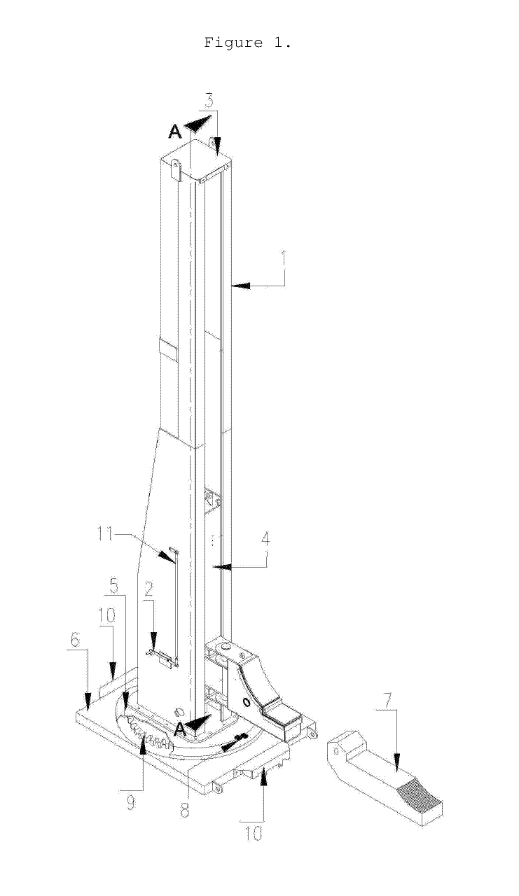

FIG. 2 is a detail of the A-A′ longitudinal section of the central rotating column.

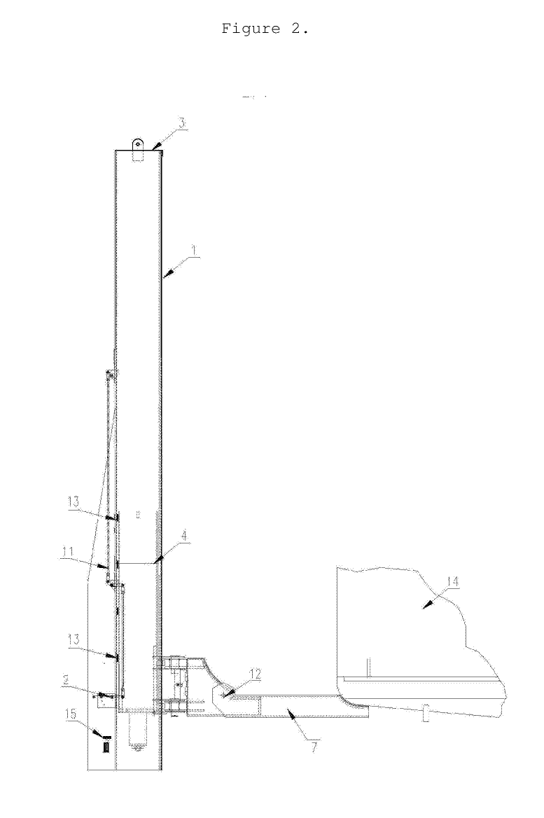

FIG. 3 is a top view of the central rotating column arranged in the dump body and water truck body exchange system with its two adjacent working positions.

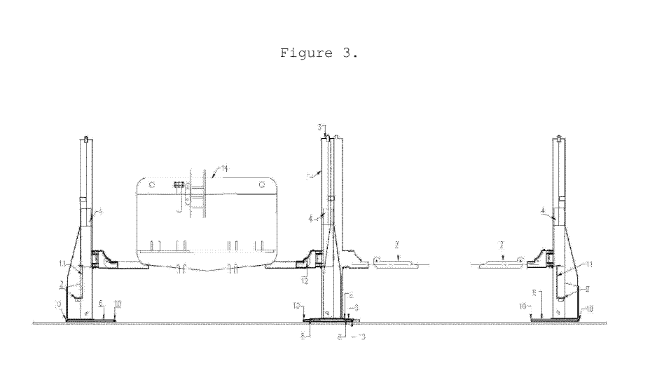

FIG. 4 is a perspective view of the central rotating column included in the dump body and water truck body exchange system.

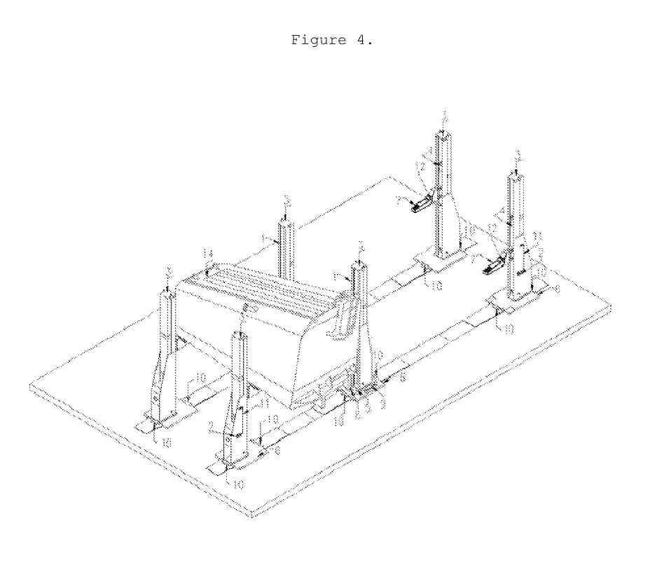

### DESCRIPTION OF THE UTILITY MODEL

The proposed utility patent model is designed for the mining industry; specifically as an aid for the mounting and dismounting of mining trucks dump bodies and water truck bodies.

Particularly, the present invention relates to a central rotating column having autonomous mobility and including operational safety accessories for its vertical and horizontal movements and a turning device for 36020 rotation. This central rotating column is part of a mounting and dismounting system for mining truck dump bodies and water truck bodies having two adjacent working areas.

The above mentioned operational safety accessories include:

A vertical movement adjustable mechanical safety lock that prevents accidental downward movement of the vertical travelling support arm actuated by means of an external locking lever located in the lower area of the column, thus assuring a quick and safe operation for workers. This mechanical safety lock allows positioning of the vertical travelling support arm at different height levels.

An automatic spring-actuated mechanical lock, driven by hydraulic cylinder acting on a spring mechanism,that horizontally holds the column in position blocking the horizontal movement of the column in case of failure in the hydraulic pressure, and preventing the horizontal movement of the column.

An automatic rotation lock preventing the rotation of the column during lifting operations; i.e. when the column is operating under the load of a dump body or water truck body.

A crown and pinion assembly for 360° rotational movement, so arranged that the crown is mounted on the square base supporting the column, and a motor driven pinion is mounted in the inner side of the crown, being an integral part of the rotating base of the column.

A load sensor preventing the horizontal movement of the column under load, assuring that independently of the operation mode—horizontal or vertical—should the operator try to activate a movement of the column, the operation will be blocked guaranteeing operator's safety and a safe operation.

With the drawings as reference, the present utility model comprises a central rotating column (1) made of structural steel, featuring in its interior an hydraulic oil tank supplying the central rotating column internal hydraulic system. Also built in inside the central rotation column there is a travelling structure which by means of a pin is assembled to a supporting arm, forming the vertical travelling support arm (4) assembly for vertical movements. The pin is a pivot type pin allowing the travelling support arm to turn 90° for easy access and positioning of the mining truck. The turning motion is activated and controlled by means of a remote control board.

The vertical movement of the travelling supporting arm (4) is performed by means of a hydraulic system including a hydraulic cylinder.

This travelling support arm (4) is vertically adjusted at the required height of the central rotating column (1) according to the shape and size of the dump body or water truck body. The vertical travelling support arm (4) includes an upper limit switch preventing the supporting arm from vertically travelling beyond the required height, in case of operator miscalculation of the lifting height required.

As a safety device for the vertical movement of the travelling support arm (4) in case of failure of the hydraulic system, the central rotating column (1) includes a vertical safety mechanical lock (11), automatically activated and adjustable in height within a defined range of height levels (13). The quick activation of the vertical safety mechanical lock (11) is achieved by means of an external lever (2) located in the lower area of the central rotating column (1); the vertical safety mechanical lock is unlocked to allow adjustment in height of the travelling support arm (4) and to perform the exchange of dump bodies and water tank bodies.

On this vertical travelling support arm (4) a structural steel accessory or XL extending arm (7) is mounted for the purpose of enlarging the sized of the supporting surface. The design of this XL extending arm (7) allows working and handling any kind of water truck bodies (14) existing in the market. The XL extending arm (7) assembly, disassembly and haulage to a storage area is made by means of a separate lifter, as the operator may require. The assembly of the XL extending arm (7) is performed lowering the supporting arm (4) down the central rotating column (1) to a height lower than the separate lifter carrying the XL extending arm (7), so that the XL extending arm (7) be placed on the travelling support arm (4) and automatically mounted when raising the travelling support arm (4) up along the central rotating column (1) by means of the hydraulic system of the central rotating column (1). The XL extending arm (7) is fastened to the travelling support arm (4) in its position at the central rotating column (1) by means of a pin.

The horizontal movement of the central rotating column (1) is so designed to adjust to the different widths of the dump bodies and water truck bodies supported; adjustment is made by means of hydraulic cylinders manually operated from the base (6) of the column (1); that is to say the column (1) travels horizontally independent from the other columns included in this dump body and water truck body exchange system. For the purpose of adjusting the horizontal position of the column (1) as required by the operator, the base (6) of the column (1) features a mechanical spring-actuated automatic safety lock (10). In case of hydraulic pressure failure, this safety lock prevents the horizontal movement of the column (1). Manual operation switch is located in the base of the column (1), thus avoiding miscalculations, as the operator must be right beside the column (1) to activate the column movement, resulting in a safer operation.

The column (1) rotates on its vertical axis driven by the rotational movement of the turntable (5) which comprises a crown and pinion assembly (9) mounted on the square base (6). The crown is mounted on the square base (6) and the pinion rotates, driven by a hydraulic motor, as a single assembly with the column (1).

The crown and pinion assembly (9) is toothed all around 360° in order to enable rotation of the column (1) in both directions, allowing the skid-arm (4) to access both adjacent working areas. The 360° toothed crown and pinion assembly (9) results in longer life and extended maintenance periods.

So as to avoid accidental turn of the column (1) an automatic rotation lock (8) has been installed, preventing the column rotation during lifting operations.

1. A central rotating column made of structural steel, having a horizontal hydraulically-driven movement, arranged in a dump body and water truck body exchange system, able to access two adjacent working areas, and featuring a hydraulic oil tank in its interior; the central rotating column includes a vertical travelling support arm vertically traveling by means of a hydraulic cylinder, also including a 90° swing movement; the central rotating column rotates on its vertical axis mounted on a 180° rotating turntable, the turntable includes a hydraulic motor driven crown and pinion assembly being an integral part of the base of the central rotating column comprising: an adjustable vertical safety mechanical lock activated by means of an external locking lever preventing the accidental downward travel of the vertical travelling support arm; a mechanical spring-actuated automatic safety lock adjusting the horizontal movement of the column; an automatic rotation lock preventing the column from rotating during lifting operations; an all-around toothed crown and pinion assembly allowing 360° rotation of the column; an XL extending arm attached to the travelling support arm to enable operation with water tank bodies; and a load sensor preventing the movement of the column under load.

2. A central rotating column made of structural steel, having a horizontal hydraulically-driven movement, as recited in claim 1, wherein the column includes an upper limit switch limiting the vertical travel of the travelling support arm and preventing the supporting arm from vertically travelling beyond the required height during lifting operations.

3. A central rotating column made of structural steel, having a horizontal hydraulically-driven movement, as recited in claim 1, wherein the external locking lever of the vertical safety mechanical lock is arranged in the lower area of the column.

4. A central rotating column made of structural steel, having a horizontal hydraulically-driven movement, as recited in claim 1, wherein the travelling support arm is positioned at the different height levels by means of the external locking lever of the vertical safety mechanical lock.

5. A central rotating column made of structural steel, having a horizontal hydraulically-driven movement, as recited in claim 1, wherein the vertical safety mechanical lock is unlocked by means of the external locking lever for the purpose of adjusting the supporting arm in height and performing the dumb body or water tank body exchange process.

6. A central rotating column made of structural steel, having a horizontal hydraulically-driven movement, as recited in claim 1, wherein the XL extending arm is so designed to allow manipulation of any type of bodies existing in the market; the XL extending arm is assembled, disassembled and hauled to a storage area by means of a separate lifter, as the operator may require.

7. A central rotating column made of structural steel, having a horizontal hydraulically-driven movement, as recited in claim 1, wherein the assembly of the XL extending arm on the travelling support arm of the column is performed vertically moving the travelling support arm down to a height lower than the position of the XL extending arm, and, with the aid of the separate lifter, the XL extending arm is advanced on the travelling support arm, and automatically assembled upon being mounted on the travelling support arm of the column by means of the hydraulic system internal to the column.

8. A central rotating column made of structural steel, having a horizontal hydraulically-driven movement, as recited in claim 1, wherein the XL extending arm is locked in its position to the travelling support arm by means of a pin.

9. A central rotating column made of structural steel, having a horizontal hydraulically-driven movement, as recited in claim 1, wherein the mechanical spring-actuated automatic safety lock is arranged in the base of the column.

10. A central rotating column made of structural steel, having a horizontal hydraulically-driven movement, as recited in claim 1, wherein the mechanical spring-actuated automatic safety lock blocks the horizontal movement of the column in case of lack of hydraulic pressure in the horizontal movement hydraulic system.

11. A central rotating column made of structural steel, having a horizontal hydraulically-driven movement, as recited in claim 1, wherein the automatic rotation lock is located in the toothed crown and pinion assembly on the base of the column.

12. A central rotating column made of structural steel, having a horizontal hydraulically-driven movement, as recited in claim 1, wherein the automatic rotation lock prevents accidental rotation of the column in case of lack of hydraulic pressure in its hydraulic motor.

13. A central rotating column made of structural steel, having a horizontal hydraulically-driven movement, as recited in claim 1, wherein the load sensor is connected to the column hydraulic lifting system.

14. A central rotating column made of structural steel, having a horizontal hydraulically-driven movement, as recited in claim 1, wherein the load sensor prevents the horizontal movement of the column when the travelling support arm is under load in case of lack of hydraulic pressure in the lifting system.
